(19) United States
(12) Patent Application Publication
(10) Pub. No.: US 2007/0204255 A1
(43) Pub. Date: Aug. 30, 2007

(54) Net routing

(75) Inventor: Jagannathan Narasimhan, Millwood, NY (US)

Correspondence Address: HOFFMAN, WARNICK & D'ALESSANDRO LLC, 75 State Street, 14th Floor, ALBANY, NY, 12207, US

(73) Assignee: International Business Machines Corporation, Armonk, NY (US)

(21) Appl. No.: 11/364,382

(22) Filed: Feb. 28, 2006

(51) Int. Cl. G06F 17/50

(52) U.S. Cl. 716/13; 716/5

(57) ABSTRACT

A solution for routing a net based on a slew and/or delay for one or more critical sinks in the net is provided. To this extent, the solution can generate electrical connection information for a circuit by generating a routing tree for each net in the circuit. When the net includes one or more critical sinks, a path to each sink in the net can be sequentially added to the routing tree. Each sink can be processed in an order of criticality, with non-critical sinks being processed last. The path to each sink is selected based on its impact to the slew and/or delay of each critical sink currently in the routing tree. For example, the path can be selected to minimize the highest slew and/or delay value for all of the critical sinks in the routing tree. In this manner, an improved routing tree can be generated for each net that optimizes the slew and/or delay in the circuit.

### FIELD OF THE INVENTION

The invention relates generally to net routing, and more particularly, to a solution for routing a net while reducing the slew and/or delay for critical sink terminals in the net.

### BACKGROUND OF THE INVENTION

A “net” comprises a set of terminals on a chip, such as a very large scale integrated (VLSI) chip, which require electrical connection. The process of establishing the electrical connections between these terminals using wires in the available metal tracks is referred to as “routing”. An average chip may include several thousands of nets that require routing. Each net includes a “source terminal” (or “source”) from which an electrical signal originates and one or more “sink terminals” (or “sinks”) to which the electrical signal travels. Some of the sinks are critical to the timing of the entire circuit and are referred to as “critical sink terminals” (or “critical sinks”), while the remaining sinks are referred to as “non-critical sink terminals (or “non-critical sinks”).

When the metal tracks available for routing run in either the horizontal or vertical directions, a tree used for routing a net must be rectilinear. That is, each segment of the tree must run parallel to one of the orthogonal axes. Such a tree can be optimized using extra branching points call Steiner Nodes. The resulting tree that could possibly include one or more Steiner Nodes is referred to as a Rectilinear Steiner Routing Tree (RSRT).

The effects of wiring (interconnect) delays on timing parameters for a chip become increasingly important as feature sizes in the chip decrease with scaling. To date, routing solutions seek to improve performance by optimizing (e.g., minimizing) wire length and/or optimizing the timing of the signals from the source to all critical sinks in the net. In general, current approaches can be classified as either spanning tree-based approaches or maze router-based approaches. The spanning tree-based approaches seek to minimize timing, wire length, and/or Elmore delays for the net. However, these approaches frequently do not adequately account for blockages and/or congestion in the routing. Conversely, the maze router-based approaches account for blockages and/or congestion, but are often too time consuming for use in early optimization, require sophisticated strategies to reduce their overall run time, and/or do not account for the timing for the net. In both approaches, other factors for effective routing, such as slew and/or a delay minimization for the electrical signal at each critical sink is not considered when routing the net.

In light of the above, a need exists for a solution for routing a net that addresses the problems discussed herein and/or other problems recognizable by one in the art.

### SUMMARY OF THE INVENTION

The invention provides a solution for routing a net based on a slew and/or delay for one or more critical sinks in the net. To this extent, the solution can generate electrical connection information for a circuit by generating a routing tree for each net in the circuit. When the net includes one or more critical sinks, a path to each sink in the net can be sequentially added to the routing tree. Each sink can be processed in an order of criticality, with non-critical sinks being processed last. The path to each sink is selected based on its impact on the slew and/or delay of each critical sink currently in the routing tree. For example, the path can be selected to minimize the highest slew and/or delay value for all of the critical sinks in the routing tree. In this manner, an improved routing tree can be generated for each net that optimizes the slew and/or delay in the circuit.

A first aspect of the invention provides a method of routing a net, the method comprising: obtaining a net that includes a source and a first critical sink; and generating a routing tree for the net based on at least one of a slew or a delay for the first critical sink.

A second aspect of the invention provides a system for routing a net, the system comprising: a system for obtaining a net that includes a source and a first critical sink; and a system for generating a routing tree for the net based on at least one of a slew or a delay for the first critical sink.

A third aspect of the invention provides a program product stored on a computer-readable medium, which when executed, enables a computer infrastructure to route a net, the program product comprising computer program code for enabling the computer infrastructure to: obtain a net that includes a source and a first critical sink; and generate a routing tree for the net based on at least one of a slew or a delay for the first critical sink.

A fourth aspect of the invention provides a method of generating electrical connection information for a circuit, the method comprising: obtaining a set of nets for the circuit; and routing each net in the set of nets, the routing including, for at least one net that includes a critical sink, generating a routing tree based on at least one of a slew or a delay for the critical sink.

A fifth aspect of the invention provides a system for generating electrical connection information for a circuit, the system comprising: a system for obtaining a set of nets for the circuit; and a system for routing each net in the set of nets, the routing including, for at least one net that includes a critical sink, generating a routing tree based on at least one of a slew or a delay for the critical sink.

A sixth aspect of the invention provides a program product stored on a computer-readable medium, which when executed, enables a computer infrastructure to generate electrical connection information for a circuit, the program product comprising computer program code for enabling the computer infrastructure to: obtain a set of nets for the circuit; and route each net in the set of nets, the routing including, for at least one net that includes a critical sink, generating a routing tree based on at least one of a slew or a delay for the critical sink.

A seventh aspect of the invention provides a method of generating a system for generating electrical connection information for a circuit, the method comprising: providing a computer infrastructure operable to: obtain a set of nets for the circuit; and route each net in the set of nets, the routing including, for at least one net that includes a critical sink, generating a routing tree based on at least one of a slew or a delay for the critical sink.

An eighth aspect of the invention provides a business method for generating electrical connection information for a circuit, the business method comprising managing a computer infrastructure that performs the process described herein; and receiving payment based on the managing.

The illustrative aspects of the present invention are designed to solve the problems herein described and other problems not discussed, which are discoverable by one in the art.

### BRIEF DESCRIPTION OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative net that comprises three terminals.

FIG. 2 shows an illustrative circuit representing a lumped capacitance model.

FIG. 3 shows illustrative plots of slew and delay versus a shared wire length.

FIG. 4 shows an illustrative pair of delay curves for two critical sinks.

FIG. 5 illustrates the addition of a new sink to an existing routing tree that includes at least one critical sink.

FIG. 6 shows an illustrative environment for generating electrical connection information for a circuit according to an embodiment of the invention.

FIG. 7 shows an illustrative process for generating electrical connection information for each net in a circuit according to an embodiment of the invention.

FIG. 8 shows an illustrative process for generating a routing tree according to an embodiment of the invention.

FIGS. 9A-D show an illustrative process for adding a path to a sink from a routing tree according to one embodiment of the invention.

FIG. 10 shows an illustrative process for calculating the candidate connection point.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION

For convenience, the Detailed Description is organized into the following sections:

I. Delay and Slew Analysis

II. Sink Addition Analysis

III. Computerized Implementation

IV. Circuit Processing

V. Net Processing

VI. Sink Processing

### VII. Additional Embodiments

I. Delay and Slew Analysis

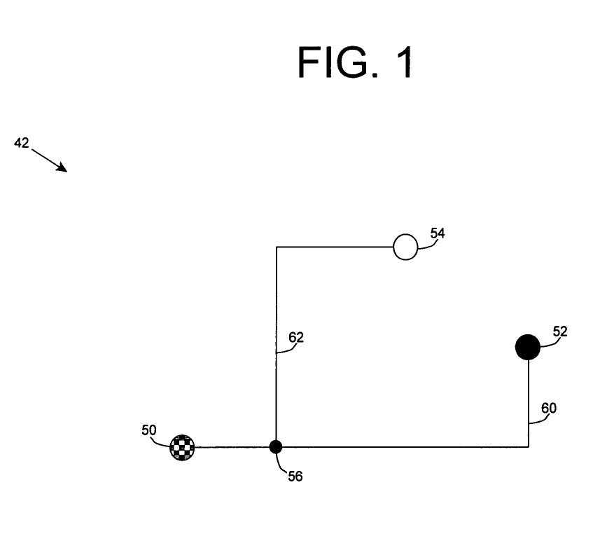

In order to more fully understand how electrical connection information can be generated for a circuit according to an embodiment of the invention, a discussion of various properties of delay and slew is included herein. To this extent, FIG. 1 shows an illustrative net 42 that comprises three terminals, e.g., a source 50, s, a first critical sink 52, k, and a second sink 54, t. In this case, sink 52 is connected to source 50 via wire 60 and sink 54 is connected to source 50 via wire 62, which is connected to wire 60 at a Steiner point 56, p. Consequently, the paths for sinks 52 and 54 share a common segment of wire from source 50 to Steiner point 56.

Assuming that source 50 is connected to both sinks 52, 54 by the shortest paths, an effect of reducing the total wire length by changing an amount of wire 60, 62 that is shared by the paths can be analyzed. For example, using R to denote the resistance of source 50; dₖ and dₜ to denote the shortest distances from source 50 to sinks 52, 54, respectively; Cₖ and Cₜ to denote the capacitances of sinks 52, 54, respectively; r and c to denote the resistance and capacitance per unit length of wire, respectively; Delay_{R} to denote the delay due to the resistance of source 50; Delay_{W} to denote the delay at critical sink 52 due to the wire; and l to denote the shared length of wire between dₖ and dₜ, then the delay to critical sink 52, denoted by Delay, can be calculated using the Elmore model by:
Delay=Delay_{R}+Delay_{W}=A₁+A₂l−A₃l² Equation 1
Where,

A₁=R(cdₖ+cdₜ+Cₖ+Cₜ)+rcdₖ²−rCₖdₖ,

A₂=rcdₜ+rCₜ−Rc, and

A₃=rc.

In particular, the delay due to the resistance of source 50 (Delay_{R}) can be computed by multiplying the resistance of source 50 by the downstream capacitance, which is given by the sum of the capacitances of the wire and each sink 52, 54, thereby yielding the equation:
Delay_{R}=R[c(dₖ+dₜ−l)+Cₖ+Cₜ]

Further, the delay at critical sink 52 due to the wire (Delay_{W}) can be determined by computing the delay due to each infinitesimal wire segment of length, dx, and integrating over the length of the wire. To this extent, Delay_{W} can be computed by integrating over the wire segment from source 50 to Steiner point 56 to obtain Delayₛₚ, integrating over the wire segment from Steiner point 56 to critical sink 52 to obtain Delayₚₖ, and adding the two (Delayₛₚ+Delayₚₖ). For Delayₛₚ, the capacitance of all the wire to both sinks 52, 54, as well as the sink capacitances should be considered, yielding the equation:

$$\begin{matrix}{Delay}_{ sp} = {\int }_{0}^{ l} ( {ⅆ}_{ t} + {ⅆ}_{ k} - l - x ) rcdx + {\int }_{0}^{ l} ( {C}_{ t} + {C}_{ k } ) r ⅆ \\ = r [ c ( {d}_{t} + {d}_{k} ) + {C}_{k} + {C}_{t} ] {d}_{sp} - 3 {rcl}^{2} / 2.\end{matrix} x$$

For Delayₚₖ, only the capacitance of the wire from Steiner point 56 to critical sink 52 and the capacitance of critical sink 52 needs to be considered, yielding the equation:

$$\begin{matrix}{Delay}_{p k} = {\int }_{0}^{{d}_{k} - l} ( {ⅆ}_{ k} - l - x ) rcdx + {\int }_{0}^{{d}_{k} - l} {C}_{k} r ⅆ \\ = r [ c ( {d}_{k} - l ) + {C}_{k} ] ( {d}_{k} - l ) - {rc ( {d}_{k} - l )}^{2} / 2 ,\end{matrix} x$$

which simplifies to:
Delayₚₖ=rc(dₖ−l)²/2+rCₖ(dₖ−l).
Subsequently, Equation 1 is readily derived by adding the delay at critical sink 52 due to the wire to the delay due to the resistance of source 50.

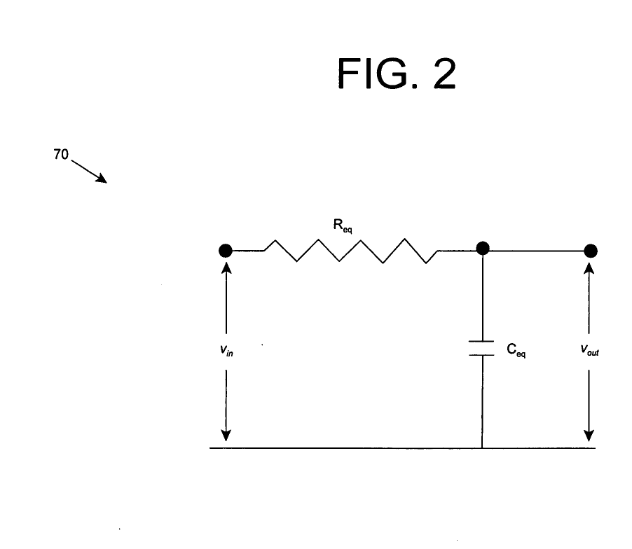

To determine the slew at the input to critical sink 52, an equivalent lumped capacitance model having a resistance, R_{eq}, and capacitance, C_{eq}, that provide the same delay as the Elmore delay from source 50 to critical sink 52 (e.g., Delay=R_{eq}C_{eq}) can be used. To this extent, FIG. 2 shows an illustrative circuit 70 representing such a lumped capacitance model. In circuit 70, a ramp input voltage, vᵢₙ, can be represented by the formula vᵢₙ=βt, where βis a constant, and t is time. In this case, an output voltage, vₒᵤₜ, can be calculated as:
vₒᵤₜ=β[t−R_{eq}C_{eq}+R_{eq}C_{eq}e^{-(t/ReqCeq)}]=β[t−Delay(1+e^{-t/Delay})] Equation 2

In general, the slew can be defined as an amount of time that it takes for an input voltage to rise (fall) from ten (ninety) percent of V_{DD} to ninety (ten) percent of V_{DD}. In this case, β can be calculated as β=0.8V_{DD}/sᵢₙ, where sᵢₙ is the slew for the ramp input voltage. Substituting this value into Equation 2, results in the equation:
vₒᵤₜ=0.8V_{DD}[t−Delay(1+e^{-t/Delay})]/sᵢₙ
When vₒᵤₜ=γV_{DD}, where 0≦γ≦1.0, then 0.8[t−Delay(1+e^{-t/Delay})]/γsᵢₙ=1. Taylor series expansion of the exponential results in the equation:
0.8V_{DD}[t−Delay+Delay(1−t/Delay+t²/2Delay²−t³/6Delay³ . . . )]/γsᵢₙ=1.
Neglecting all terms higher than the second order, yields the equation:
t²/2Delay=γsᵢₙ/0.8,
which in turn yields:
t=sqrt(2γsᵢₙDelay/0.8)

The slew for the output voltage, sₒᵤₜ, can be calculated as the time that it takes for γ to go from 0.1 to 0.9. Therefore, the output voltage slew can be calculated by:
sₒᵤₜ=sqrt(sᵢₙDelay)[sqrt(2.25)−sqrt(0.25)]=sqrt(sᵢₙDelay)
Since Delay=A₁+A₂l−A₃l², then
sₒᵤₜ=sqrt[sᵢₙ(A₁+A₂l−A₃l²)] or sₒᵤₜ²=sᵢₙ(A₁+A₂l−A₃l²)

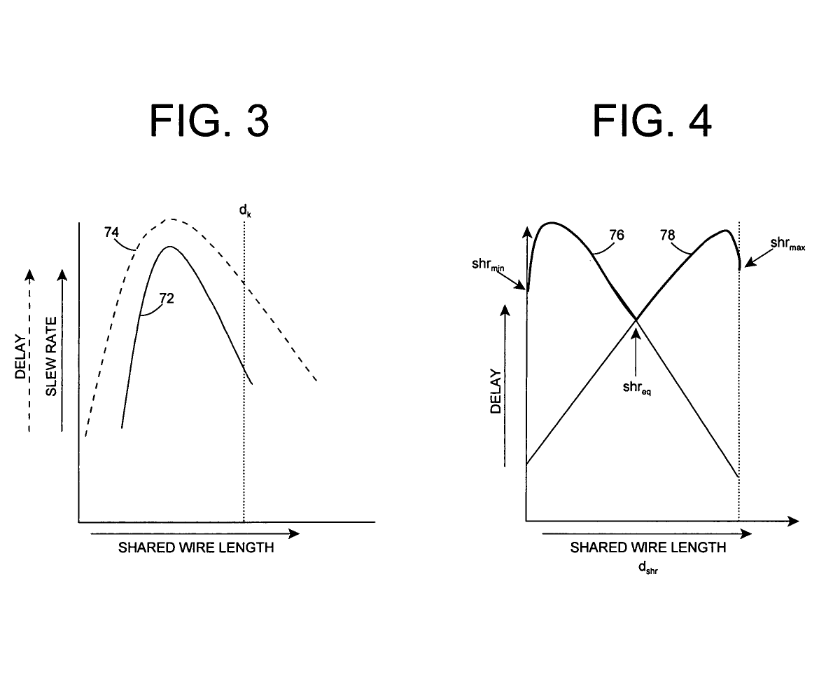

FIG. 3 shows illustrative plots of the slew for the output voltage 72, sₒᵤₜ, and Delay 74 versus a shared wire length. Both plots 72, 74 comprise an inverted cup (bell) shape. To this extent, in order to minimize the slew at the input to a sink, such as critical sink 52 (FIG. 1), it is only necessary to either share the complete wire or not share any of it, depending on the value of the source resistance, sink capacitance, and wire resistance and capacitance.

Returning briefly to FIG. 1, when both sinks 52, 54 are critical sinks, it is desirable to optimize (e.g., minimize) the delay and/or slew for both sinks 52, 54. Since both sinks 52, 54 are critical to the timing of the overall circuit, any delay and/or slew to either sink 52, 54 adversely impacts the performance of the entire circuit. To this extent, it is desirable to minimize the maximum of the delays and/or slews for both sinks 52, 54.

For example, FIG. 4 shows an illustrative pair of delay curves 76, 78 for two critical sinks, such as sinks 52, 54 of FIG. 1. As illustrated, in addition to computing delays (and/or slew) with no sharing (e.g., shrₘᵢₙ) and with maximum sharing (e.g., shrₘₐₓ), the sharing that results in both delays being equal (e.g., shr_{eq}) also should be calculated. Using Equation 1, the delay for two critical sinks, Delayₖ₁ and Delayₖ₂, can be calculated as:
Delayₖ₁=A₁+A₂dₛₕᵣ−A₃d²ₛₕᵣ
Delayₖ₂=B₁+B₂dₛₕᵣ−B₃d²ₛₕᵣ
where the coefficients A₁, A₂, A₃, B₁, B₂ and B₃ are computed as shown in Equation 1. The optimal delay (and/or slew) for the net will occur when there is minimum sharing (shrₘᵢₙ), maximum sharing (shrₘₐₓ), or when both delays are equal (shr_{eq}). Since the coefficients are known, the length of the path to be shared can be determined by solving for dₛₕᵣ when Delayₖ₁ and Delayₖ₂ are equal, resulting in the equation:
A₁−B₁+(A₂−B₂)dₛₕᵣ−(A₃−B₃)d²ₛₕᵣ=0 Equation 3
In certain instances, the solution to the equation will result in a sharing value that is beyond the bounds of the path from the source to the critical sink, or result in imaginary roots. In these cases, the distance to be shared is undefined, and hence only the cases of maximum sharing or no sharing need to be considered.
II. Sink Addition Analysis

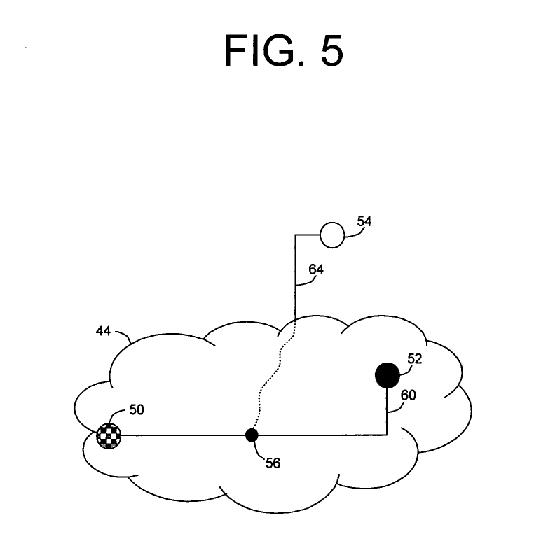

FIG. 5 illustrates the addition of a new sink 54 to an existing routing tree 44 that includes at least one path 60 to a critical sink 52. Using delay as an illustrative example and assuming that sink 54 is a non-critical sink, then the addition of a path to sink 54 to routing tree 44 can be done in a manner that provides the minimum delay to critical sink 52.

To this extent, in the Elmore delay model, an increase in delay at critical sink 52 due to the addition of sink 54 can be computed by summing the increase in Delay_{R}, which is due to the increased capacitance seen by source 50 resistance, R, and an increase in delay, Delayₛₕᵣ, due to the additional wire resistance and capacitance of any shared portion, pₛₕᵣ, of path 60, pₛₖ. Using pₛₜ to denote the shortest path from source 50 to sink 54 and d₅₁ to denote the corresponding distance, p_{new} to denote the portion 64 of pₛₙ that is added to routing tree 44 and d_{new} to denote the corresponding distance, and dₛₕᵣ to denote the distance of pₛₕᵣ then Delay_{R} and Delayₛₕᵣ can be calculated by the equations:
Delay_{R}=R(cd_{new}+Cₜ) and
Delayₛₕᵣ=rcdₛₕᵣd_{new}+rdₛₕᵣCₜ.

To minimize Delay_{R}+Delayₛₕᵣ, the delay due to p_{new} 64, Delay_{new}, must be minimized in conjunction with the product Delayₛₕᵣ·Delay_{new}. Consider the addition of a sink t using a new wire starting at some point located between two branching points, v₁ and v₂, on the path pₛₖ 60 of the existing routing tree 44. Each branching point comprises a location in routing tree 44 that includes more than two edges in routing tree 44 (e.g., Steiner point 56) and/or includes a terminal of the net (e.g., source 50, sink 52). Because branching points v₁ and v₂ are on path 60, v₁ can be considered to be a virtual source (or actual source 50) since branching point v₂ is connected to source 50 via branching point v₁, and v₂ can be considered to be a critical sink since branching point v₁ is connected to critical sink 52 via branching point v₂. In this case, the curve between the delay at branching point v₂ and the shared wire length comprises inverted cup 74 of FIG. 3. Therefore, the best delay at branching point v₂ can only be obtained when the new wire starts at either branching point v₁ or v₂. Consequently, in order to obtain the best delay, sink 54 can only be connected to a sub-tree of routing tree 44 that is rooted at a branching point (including source 50 and sink 52) that is on path 60 of routing tree 44.

To find the desired branching point, xᵢ can represent the set of branching points on path 60, where 0≦i≦m, x₀ corresponds to source 50 and xₘ corresponds to critical sink 52, and pⁱ_{new} (dⁱ_{new}) can represent the additional path 64 (length) that is required to be added to the sub-tree rooted at the corresponding branching point xᵢ, and pⁱₛₕᵣ (dⁱₛₕᵣ) can represent the shared portion (length) of path 60. If a chosen branching point xᵢ minimizes dⁱ_{new} then the amount of shared resistance that must drive the extra capacitance could potentially become very high. On the other hand, choosing a branching point xᵢ that minimizes dⁱₛₕᵣ could potentially make dⁱ_{new} very large. Consequently, the desired branching point is found by locating the branching point xᵢ that corresponds to the minimum increase in delay, Delayᵢ, which can be calculated using the equation:
Delayᵢ=R(cdⁱ_{new}+cₜ)+rcdⁱ_{new}dⁱₛₕᵣ+rcₜdⁱₛₕᵣ.
The optimum branching point, xₒₚₜ, is computed by evaluating delays obtained by connections using the shortest wire from sink 54 to sub-trees rooted at each possible branching point xᵢ, and choosing the one with the lowest delay, e.g., branching point xₒₚₜ=xᵢ [symbol] Delayᵢ≦Delayⱼ, 0≦i,j≦m, i≠j.

The analysis can be readily extended to a generic routing tree 44 that may include multiple critical and/or non-critical sinks. For example, when multiple critical sinks 52 are included in routing tree 44, branching points along the paths from source 50 to each critical sink 52 can be analyzed. Further, when sink 54 comprises a critical sink, the solution can evaluate the delays for each critical sink 52 currently in routing tree 44 as well as the delay for sink 54, which is being added to routing tree 44. Additionally, the equal delay point(s) for sink 54 and each critical sink 52 already in routing tree 44 can be analyzed.

As discussed herein, delay is used as an illustrative property that is analyzed in order to generate routing tree 44. However, it is understood that the same procedure can be used to analyze slew when generating routing tree 44. To this extent, since slew curve 72 (FIG. 3) has the same inverted cup shape as delay curve 74 (FIG. 3), the procedure will yield an optimum slew-based routing tree 44. Further, it is understood that both delay and slew can be analyzed in generating routing tree 44. For example, both delay and slew values can be determined, and the path that provides the lowest maximum for delay and slew can be selected. In any event, it is understood that routing tree 44 may differ depending on whether delay, slew, or some combination thereof is used in the analysis.

Since only branching points on path 60 are considered, the analysis can be performed in O(g²) time, where g is the number of grid points. In practice, the analysis is extremely fast since the number of branching points on path 60 is usually very small. If the generated routing tree 44 is used for estimation purposes only, then a coarse grid can be used to make the analysis faster. Further, different threshold values can be used against which to compare the delay values for generating an optimal routing tree 44.

III. Computerized Implementation

As indicated above, the invention provides a solution for routing a net based on a slew and/or delay for one or more critical sinks in the net. To this extent, the solution can generate electrical connection information for a circuit by generating a routing tree for each net in the circuit. When the net includes one or more critical sinks, a path to each sink in the net can be sequentially added to the routing tree. Each sink can be processed in an order of criticality, with non-critical sinks being processed last. The path to each sink is selected based on its impact to the slew and/or delay of each critical sink currently in the routing tree. For example, the path can be selected to minimize the highest slew and/or delay value for all of the critical sinks in the routing tree. In this manner, an improved routing tree can be generated for each net that optimizes the slew and/or delay in the circuit. As used herein, unless otherwise noted, the term “set” means one or more.

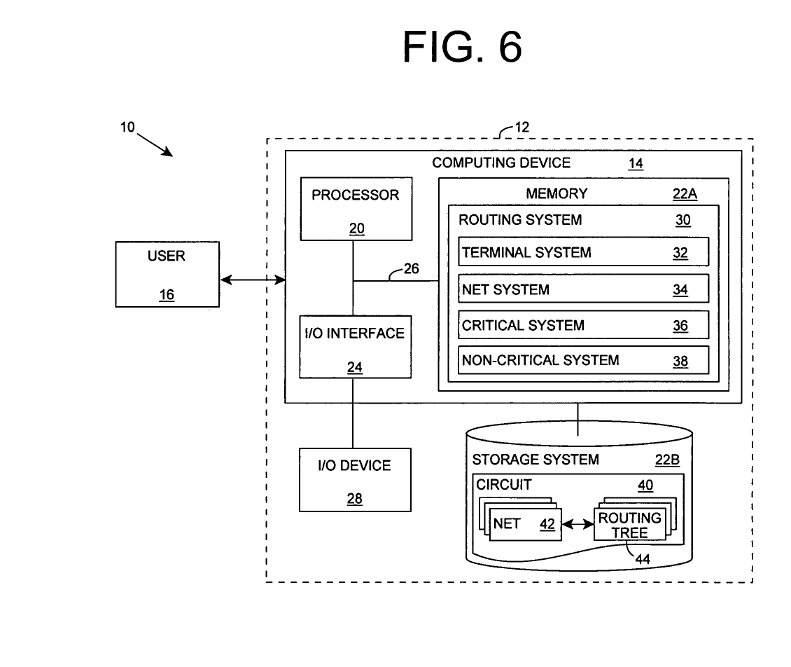

FIG. 6 shows an illustrative environment 10 for generating electrical connection information for a circuit 40 according to an embodiment of the invention. To this extent, environment 10 includes a computer infrastructure 12 that can perform the process described herein in order to route a set of nets 42 in circuit 40. In particular, computer infrastructure 12 is shown including a computing device 14 that comprises a routing system 30, which makes computing device 14 operable to generate electrical connection information for circuit 40 by performing the process described herein.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as routing system 30, which is stored in memory 22A and/or storage system 22B. While executing computer program code, processor 20 can read and/or write data, such as circuit 40, to/from memory 22A, storage system 22B, and/or I/O interface 24. Bus 26 provides a communications link between each of the components in computing device 14. I/O device 28 can comprise any device that enables an individual to interact with computing device 14 or any device that enables computing device 14 to communicate with one or more other computing devices using any type of communications link.

In any event, computing device 14 can comprise any general purpose computing article of manufacture capable of executing computer program code installed thereon (e.g., a personal computer, server, handheld device, etc.). However, it is understood that computing device 14 and routing system 30 are only representative of various possible equivalent computing devices that may perform the process described herein. To this extent, in other embodiments, the functionality provided by computing device 14 and routing system 30 can be implemented by a computing article of manufacture that includes any combination of general and/or specific purpose hardware and/or computer program code. In each embodiment, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of communications link, such as a network, a shared memory, or the like, to perform the process described herein. Further, while performing the process described herein, one or more computing devices in computer infrastructure 12 can communicate with one or more other computing devices external to computer infrastructure 12 using any type of communications link. In either case, the communications link can comprise any combination of various types of wired and/or wireless links; comprise any combination of one or more types of networks (e.g., the Internet, a wide area network, a local area network, a virtual private network, etc.); and/or utilize any combination of various types of transmission techniques and protocols.

As discussed further herein, routing system 30 enables computing infrastructure 12 to generate electrical connection information for circuit 40, and in particular, route each net 42 in circuit 40. To this extent, routing system 30 is shown including a terminal system 32, a net system 34, a critical system 36, and a non-critical system 38. Operation of each of these systems is discussed further herein. However, it is understood that some of the various systems shown in FIG. 6 can be implemented independently, combined, and/or stored in memory for one or more separate computing devices that are included in computer infrastructure 12. Further, it is understood that some of the systems and/or functionality may not be implemented, or additional systems and/or functionality may be included as part of computing infrastructure 12.

IV. Circuit Processing

Regardless, the invention provides a solution for generating electrical connection information for circuit 40. To this extent, terminal system 32 can obtain terminal information for circuit 40 using any known solution. In particular, terminal system 32 can obtain a set of terminals for circuit 40. Each terminal comprises a location in circuit 40 at which one or more electrical connections may be desired. As discussed herein, circuit 40 generally will include a set of source terminals (e.g., sources) and a set of sink terminals (e.g., sinks). Each source can comprise an output of an electrical signal, while each sink can comprise an input for an electrical signal.

Additionally, terminal system 32 can obtain criticality information for the terminals. For example, terminal system 32 can obtain an indication of whether each sink is critical or non-critical (e.g., from user 16 and/or circuit 40). Further, for each critical sink, terminal system 32 can obtain a criticality that indicates a relative criticalness with respect to other critical sinks (e.g., on a scale of zero to one hundred). Still further, the terminal information can comprise a location of each terminal (e.g., on a two dimensional grid), metal track information for electrically connecting the terminals, and/or one or more electrical characteristics (e.g., resistance, capacitance, and/or the like) for each terminal.

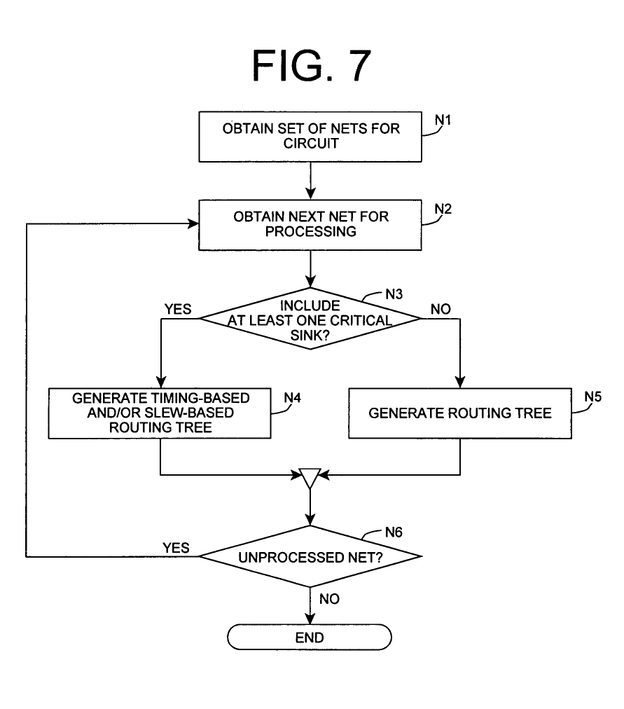

In order to implement circuit 40, the various terminals must be electrically connected. To this extent, net system 34 can process a set of nets 42 for circuit 40 to generate electrical connection information for circuit 40. In particular, FIG. 7 shows an illustrative process that net system 34 can implement to generate electrical connection information for each net 42 in circuit 40 according to an embodiment of the invention. Referring to FIGS. 6 and 7, in step N1, net system 34 can obtain a set of nets 42 for circuit 40 using any solution. For example, net system 34 can generate a user interface that enables a user 16 to define and/or edit each net 42. Further, another system can communicate the set of nets 42 to net system 34 using an application program interface (API) or the like.

In any event, in step N2, net system 34 can obtain a next net 42 for processing. Each net 42 in the set of nets 42 can be processed in any order. In one embodiment, all nets 42 that include one or more critical sinks (e.g., critical nets) are processed before nets 42 that do not include any critical sinks. Further, multiple critical nets 42 can be processed based on a corresponding relative criticality of each net 42. For example, net system 34 can assign each critical net 42 a criticality that corresponds to the highest criticality in the set of critical sinks included in the critical net 42. Alternatively, nets 42 can be processed in an order that is determined by on one or more wiring constraints, a total number of sinks, a distance between the terminals, etc.

In step N3, net system 34 can determine if the current net 42 being processed includes one or more critical sinks. If so, then in step N4, as discussed further herein, critical system 36 generates a routing tree 44 for net 42 that is based on a slew and/or delay for each critical sink in net 42. Otherwise, in step N5, non-critical system 38 generates a routing tree 44 for net 42 using any known solution. Various solutions can be used to generate routing tree 44 for a non-critical net 42, including a spanning tree-based approach, a maze router-based approach, and/or the like. In any event, after generating routing tree 44 for the current net 42, in step N6, net system 34 determines if any nets 42 remain to be processed, and if so, flow returns to step N2. Otherwise, processing is complete, and circuit 40 includes electrical connection information for all nets 42 included therein.

V. Net Processing

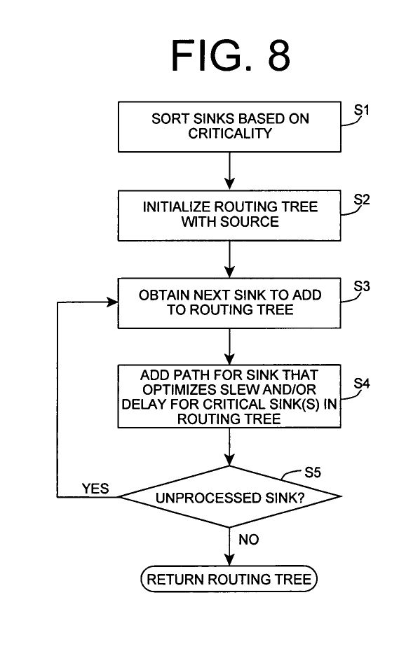

Critical system 36 can process the set of sinks in each critical net 42 in any order. For example, FIG. 8 shows an illustrative process that critical system 36 can implement to generate routing tree 44 according to an embodiment of the invention. Referring to FIGS. 6 and 8, in step S1, critical system 36 can sort each sink in net 42 based on its corresponding criticality. For example, critical system 36 can initially process all critical sinks in net 42 and then process all non-critical sinks in net 42. Further, when the critical sinks have a corresponding criticality, critical system 36 can process the critical sinks in order from the most critical sink to the least critical sink. Still further, critical system 36 can order critical sinks having the same criticality and/or non-critical sinks using any known solution, including for example, by distance from source 50 (FIG. 1) of net 42, a distance from a next closest sink, etc.

In step S2, critical system 36 initializes routing tree 44 with source 50 (FIG. 1) for net 42. In step S3, critical system 36 obtains the next sink to add to routing tree 44. In step S4, as discussed further herein, critical system 36 adds a path for the sink to routing tree 44 such that the path optimizes the slew and/or delay for each of the critical sink(s) currently in routing tree 44. In step S5, critical system 36 determines if there are any unprocessed sinks in net 42, and if so, flow returns to step S3. Otherwise, critical system 36 can return routing tree 44 for net 42.

VI. Sink Processing

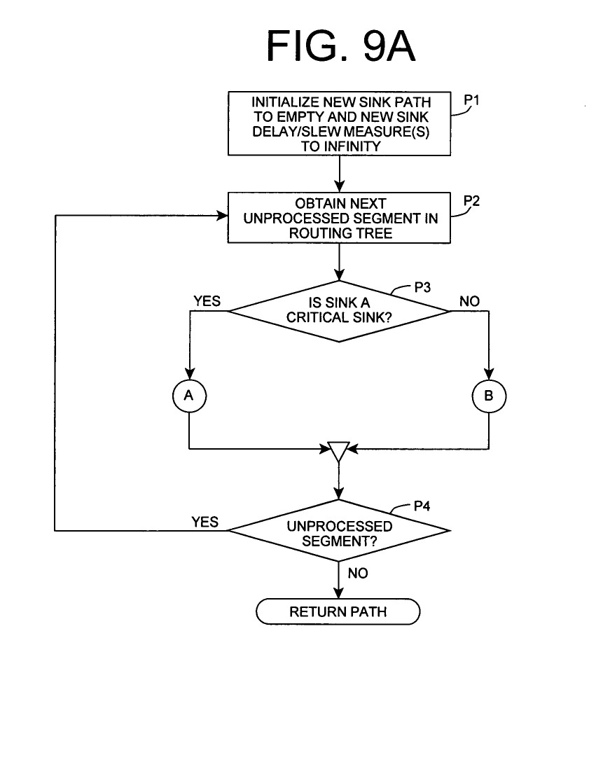

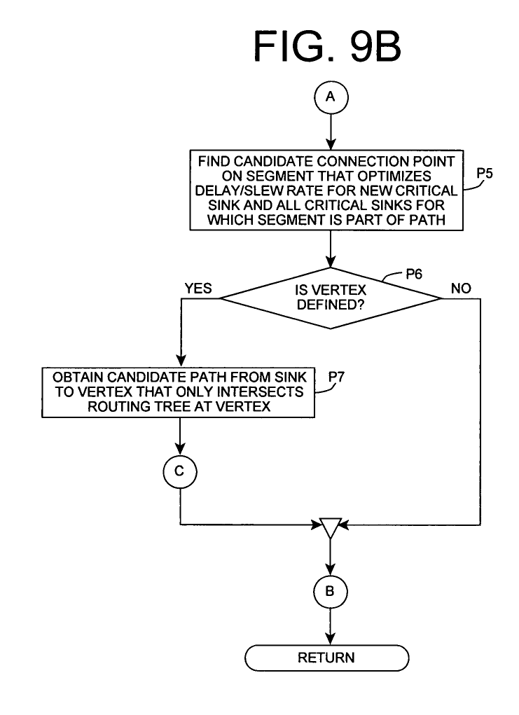

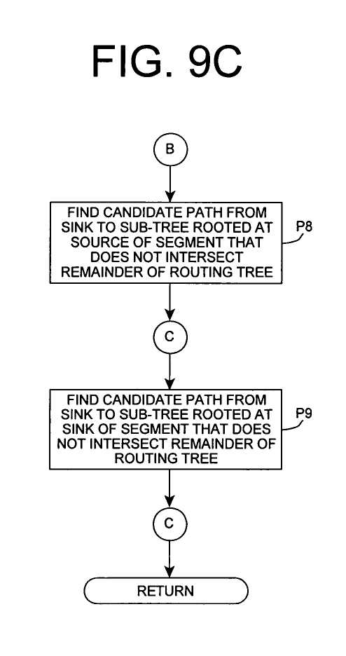

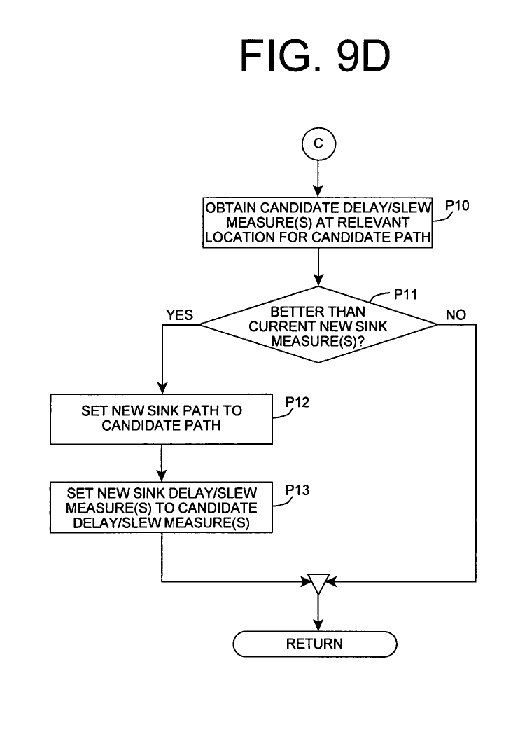

As noted in step S4, critical system 36 adds a path for each sink in net 42 such that the path optimizes the slew and/or delay for each critical sink (including, if applicable, the current sink being processed) in routing tree 44. In one embodiment, an optimal slew and/or delay comprises the lowest value for the highest slew and/or delay for all the critical sinks in routing tree 44. To this extent, FIGS. 9A-D show an illustrative process for adding a path to a sink to a routing tree, which can be implemented by critical system 36 (FIG. 6), according to one embodiment of the invention. Referring to both FIGS. 6 and 9A, in step P1, critical system 36 can initialize a new sink path to empty and a new sink delay and/or slew measure to infinity.

In step P2, critical system 36 can obtain an unprocessed segment in routing tree 44. As discussed herein, each segment comprises a first branching point and a second branching point, in which the second branching point is electrically connected to source 50 (FIG. 1) via the first branching point. Critical system 36 can obtain segments in routing tree 44 in any order. For example, critical system 36 can first select a segment starting at source 50 and ending at a first branching point 56 (FIG. 1), followed by a segment starting at branching point 56, etc.

In any event, in step P3, critical system 36 can determine whether the sink being added to routing tree 44 comprises a critical sink or a non-critical sink. Based on this determination, critical system 36 will perform the corresponding analysis of a delay and/or slew-based path to the sink. FIG. 9B shows the processing that critical system 36 (FIG. 6) can perform when adding a path to a new critical sink. In step P5, critical system 36 can find a candidate connection point (e.g., vertex) on the segment that optimizes the delay and/or slew for the new critical sink and all critical sinks for which the segment is a part of the corresponding path to source 50 (FIG. 1).

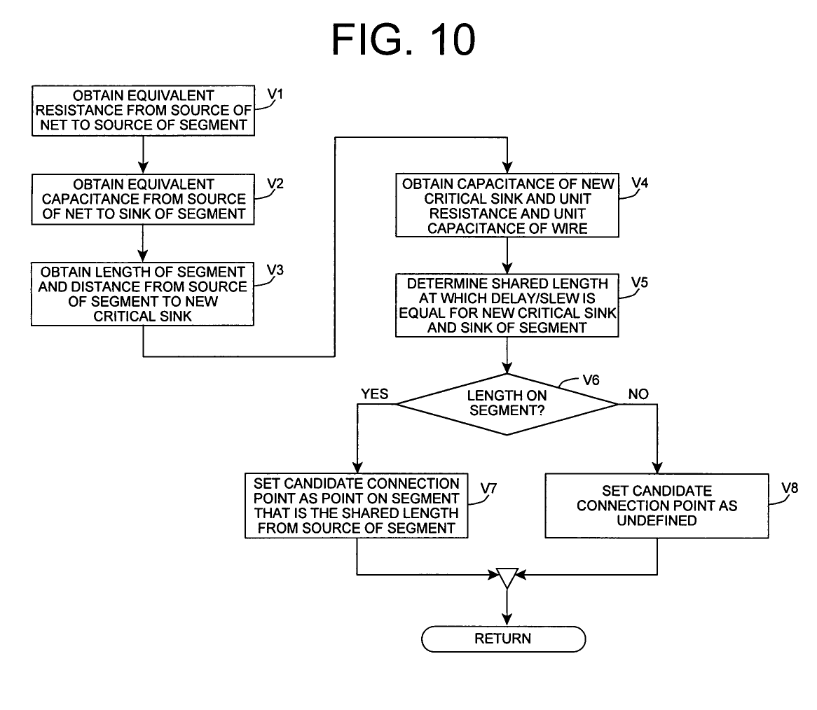

For example, critical system 36 can use Equation 3 discussed herein to calculate a candidate connection point. To this extent, FIG. 10 shows an illustrative process for calculating the candidate connection point. Referring to FIGS. 5, 6 and 10, in step V1, critical system 36 can obtain an equivalent resistance for the portion of routing tree 44 from source 50 to the first (source) branching point of the segment. In step V2, critical system 36 can obtain an equivalent capacitance for the portion of routing tree 44 from source 50 to the second (sink) branching point of the segment. In step V3, critical system 36 can obtain a length of the segment and a distance from the source branching point to new critical sink 54. In step V4, critical system 36 can obtain a capacitance of new critical sink 54 and a unit capacitance of wire. In each of steps V1-4, critical system 36 can obtain the corresponding data using any solution, including for example, calculating the data, retrieving the data from stored data, such as terminal information, receiving the data from another system, and/or the like.

In any event, using the data obtained in steps V1-4, in step V5, critical system 36 can determine a shared length of the segment at which the delay and/or slew is equal for both new critical sink 54 and the sink branching point of the segment, e.g., by solving Equation 3. In step V6, critical system 36 can determine if the shared length is on the segment, e.g., critical system 36 can determine if the shared length is both a real number and is less than the length of the segment. If so, then in step V7, critical system 36 can set the candidate connection point as the point on the segment that is approximately the shared length from the source branching point. Otherwise, in step V8, critical system 36 can set the candidate connection point to undefined.

Returning to FIGS. 5, 6 and 9B, in step P6, critical system 36 can determine whether the candidate connection point is defined. If so, then in step P7, critical system 36 can obtain a candidate path from new critical sink 54 to the candidate connection point that only intersects the current routing tree 44 at the candidate connection point. To this extent, critical system 36 can find (e.g., generate) the candidate path and/or receive the candidate path from another system. In either case, the candidate path can be generated using any solution, including for example, any known spanning tree-based or maze router-based approach.

Once critical system 36 has obtained a candidate path, critical system 36 can determine whether the candidate path may be desirable to use. For example, critical system 36 can compare the delay and/or slew for the candidate path with the current new sink delay and/or slew measure. To this extent, FIG. 9D shows the processing that critical system 36 can perform to evaluate the candidate path. In particular, in step P10, critical system 36 can obtain a candidate delay and/or slew measure at the second branching point for the segment on which the candidate connection point is included. To this extent, critical system 36 can calculate the candidate delay and/or slew measure as discussed herein and/or obtain the candidate delay and/or slew measure from another system. In step P11, critical system 36 can determine if the candidate delay and/or slew measure is better (e.g., lower) than the current new sink delay and/or slew measure. If so, then in step P12, critical system 36 can set the new sink path to the candidate path, and in step P13, critical system 36 can set the new sink delay and/or slew measure to the candidate delay and/or slew measure. Otherwise, the current new sink path and new sink delay and/or slew measure are left alone.

Returning to FIG. 9B, after analyzing a candidate connection point and/or determining that no candidate connection point exists in step P6, critical system 36 (FIG. 6) can analyze the sub-trees for the segment. Alternatively, as shown in FIG. 9A, when critical system 36 determines in step P3 that the new sink comprises a non-critical sink, flow can proceed directly to analyze the sub-trees for the segment. In either case, turning to FIG. 9C, in step P8, critical system 36 can obtain a candidate path that connects new sink 54 (FIG. 5) to a sub-tree rooted at the first (e.g., source) branching point of the segment, which does not intersect the remainder of routing tree 44. Subsequently, critical system 36 can evaluate and/or select the candidate path by comparing candidate delay and/or slew measure(s) at the first branching point with the current new sink delay and/or slew measure(s) as described herein and shown in FIG. 9D. Next, in step P9, critical system 36 can obtain a candidate path that connects the new sink to a sub-tree rooted at the second (sink) branching point of the segment, which does not intersect the remainder of routing tree 44. Again, critical system 36 can evaluate and/or select the candidate path by comparing candidate delay and/or slew measure(s) at the second branching point with the current new sink delay and/or slew measure(s) as described herein and shown in FIG. 9D.

Returning to FIG. 9A, after processing the segment, then in step P4, critical system 36 can determine whether any unprocessed segment is present in routing tree 44, and if so, flow returns to step P2 at which a subsequent segment is obtained for processing as described herein. Otherwise, all segments have been processed, and the current new sink path is returned as the delay and/or slew-optimal path for the sink.

### VI. Additional Embodiments

While shown and described herein as a method and system for generating electrical connection information for a circuit, it is understood that the invention further provides various alternative embodiments. For example, in one embodiment, the invention provides a program product stored on a computer-readable medium, which when executed, enables a computer infrastructure to generate electrical connection information for the circuit. To this extent, the computer-readable medium includes program code, such as routing system 30 (FIG. 6), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 6) and/or storage system 22B (FIG. 6) (e.g., a fixed disk, a read-only memory, a random access memory, a cache memory, etc.), and/or as a data signal traveling over a network (e.g., during a wired/wireless electronic distribution of the program product).

In another embodiment, the invention provides a method of generating a system for generating electrical connection information for a circuit. In this case, a computer infrastructure, such as computer infrastructure 12 (FIG. 6), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing device 14 (FIG. 6), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising, and/or fee basis. That is, a service provider, such as a chip manufacturer, could offer to generate electrical connection information for a circuit as described herein. In this case, the service provider can manage (e.g., create, maintain, support, etc.) a computer infrastructure, such as computer infrastructure 12 (FIG. 6), that performs the process described herein for one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method of routing a net, the method comprising:
obtaining a net that includes a source, a first critical sink, and a second sink; and
generating a routing tree for the net based on at least one of a slew or a delay for the first critical sink, the generating including:
adding a path to the first critical sink that optimizes at least one of the slew or the delay for the first critical sink;
determining at least one of the slew or the delay for the first critical sink for each of a plurality of candidate connection points for the second sink the determining including:
obtaining a candidate path from the second sink to the candidate connection point; and
calculating the at least one of the slew or the delay for the first critical sink based on the candidate path and the candidate connection point;
identifying a connection point for the second sink from the plurality of candidate connection points, wherein the connection point optimizes at least one of the slew or the delay for the first critical sink; and
adding a path from the connection point to the second sink.

2. (canceled)

3. (canceled)

4. The method of claim 1, the determining further including obtaining at least one segment in the routing tree, the at least one segment including a first branching point and a second branching point electrically connected to the source via the first branching point.

5. The method of claim 4, the determining further including identifying a candidate connection point and corresponding candidate path for each of the at least one segments.

6. The method of claim 5, the second sink comprising a second critical sink and the identifying a candidate connection point including, for each of the at least one segments, determining whether a candidate connection point exists on the segment, the candidate connection point optimizing the at least one of the slew or the delay for the first critical sink and the second critical sink.

7. The method of claim 1, the net including a plurality of critical sinks, each having a corresponding criticality, and the generating including adding a path to each of the plurality of critical sinks in order from the most critical to the least critical.

8. The method of claim 7, the net including at least one non-critical sink, and the generating including adding a path to each of the at least one non-critical sinks after adding a path to each of the plurality of critical sinks.

9. A method of generating electrical connection information for a circuit, the method comprising:
obtaining a set of nets for the circuit; and
routing each net in the set of nets, the routing including, for at least one net that includes a source, a critical sink and a second sink, generating a routing tree based on at least one of a slew or a delay for the critical sink, the generating including:
determining at least one of the slew or the delay for the first critical sink for each of a plurality of candidate connection points for the second sink, the determining including:
obtaining a candidate path from the second sink to the candidate connection point; and
calculating the at least one of the slew or the delay for the first critical sink based on the candidate path and the candidate connection point; and
identifying a connection point for the second sink from the plurality of candidate connection points, wherein the connection point optimizes at least one of the slew or the delay for the first critical sink.

10. The method of claim 9, the generating including, for each critical sink in the net, adding a path to the critical sink that optimizes at least one of the slew or the delay for each critical sink in the routing tree.

11. The method of claim 9, the determining further including obtaining at least one segment in the routing tree, the segment including a first branching point and a second branching point electrically connected to the source via the first branching point.

12. The method of claim 9, at least one net including a plurality of critical sinks each having a corresponding criticality, and the generating including adding a path to each of the plurality of critical sinks in order from the most critical to the least critical.

13. The method of claim 12, the at least one net further including at least one non-critical sink, and the generating further including adding a path to each of the at least one non-critical sinks after adding a path to each of the plurality of critical sinks.

14. A program product stored on a computer-readable medium, which when executed, enables a computer infrastructure to generate electrical connection information for a circuit, the program product comprising computer program code for enabling the computer infrastructure to perform the method of claim 9.

15. A system for generating electrical connection information for a circuit, the system comprising:
a system for obtaining a set of nets for the circuit; and
a system for routing each net in the set of nets, the system for routing including, for at least one net that includes a source, a critical sink and a second sink, a system for generating a routing tree based on at least one of a slew or a delay for the critical sink, the system for generating including:
a system for determining at least one of the slew or the delay for the first critical sink for each of a plurality of candidate connection points for the second sink, the system for determining including:
a system for obtaining a candidate path from the second sink to the candidate connection point; and
a system for calculating the at least one of the slew or the delay for the first critical sink based on the candidate path and the candidate connection point; and
a system for identifying a connection point for the second sink from the plurality of candidate connection points, wherein the connection point optimizes at least one of the slew or the delay for the first critical sink.

16. The system of claim 15, the system for generating including, for each critical sink in the net, a system for adding a path to the critical sink that optimizes at least one of the slew or the delay for each critical sink in the routing tree.

17. The system of claim 15, the system for determining further including a system for obtaining at least one segment in the routing tree, the segment including a first branching point and a second branching point electrically connected to a source of the net via the first branching point.

18. The system of claim 15, at least one net including a plurality of critical sinks, each having a corresponding criticality, and the system for generating including a system for adding a path to each of the plurality of critical sinks in order from the most critical to the least critical.

19. The system of claim 18, the at least one net further including at least one non-critical sink, and the system for generating further including a system for adding a path to each of the at least one non-critical sinks after adding a path to each of the plurality of critical sinks.

20. A method of generating a system for generating electrical connection information for a circuit, the method comprising:
providing a computer infrastructure operable to:
obtain a set of nets for the circuit; and
route each net in the set of nets, the routing including, for at least one net that includes a a source, a critical sink and a second sink, generating a routing tree based on at least one of a slew or a delay for the critical sink, the generating including:
determining at least one of the slew or the delay for the first critical sink for each of a plurality of candidate connection points for the second sink the determining including:
obtaining a candidate path from the second sink to the candidate connection point; and
calculating the at least one of the slew or the delay for the first critical sink based on the candidate path and the candidate connection point; and
identifying a connection point for the second sink from the plurality of candidate connection points, wherein the connection point optimizes at least one of the slew or the delay for the first critical sink.

21. The method of claim 1, wherein the calculating is based on the delay due to the source, the wire, the second sink, and the first critical sink.

22. The method of claim 9, wherein the calculating is based on the delay due to the source, the wire, the second sink, and the first critical sink.
